(19) United States
(12) Patent Application Publication
(10) Pub. No.: US 2026/0272775 A1
(43) Pub. Date: Sep. 17, 2026

(54) SOFA-TYPE MASSAGE APPARATUS

(71) Applicant: CERAGEM CO., LTD., Cheonan-si, Chungcheongnam-do (KR)

(72) Inventors: Dong Myoung Lee, Asan-si, Chungcheongnam-do (KR); Sang Ho Choi, Cheonan-si, Chungcheongnam-do (KR); Seung Jong Lee, Cheongju-si, Chungcheongbuk-do (KR)

(21) Appl. No.: 18/872,500

(22) PCT Filed: May 22, 2023
(86) PCT No.: PCT/KR2023/006929

§ 371 Date: Dec. 6, 2024

(30) Foreign Application Priority Data
Jun. 9, 2022 (KR) 10-2022-0070000

(51) Int. Cl. A61H 39/04; A61H 7/00

(52) U.S. Cl. CPC A61H 39/04; A61H 7/004; A61H 2201/0149; A61H 2201/0161; A61H 2201/123; A61H 2201/5058

(57) ABSTRACT

The present invention relates to a massage apparatus, and more specifically, a sofa-type massage apparatus is disclosed. The sofa-type massage apparatus, according to one aspect of the present invention, comprises: a support part which has a first support surface for supporting the body of a user; a withdrawal/insertion part which has a second support surface for supporting the body of the user, and has a massage module moving along the longitudinal direction so as to massage the body of the user who is lying down on the second support surface; and a controller which controls the operation of the massage module, wherein the withdrawal/insertion part is disposed inside an accommodation space formed in the support part and may be provided so as to be withdrawable or insertable along the width direction so as to enable the second support surface to be selectively exposed to the outside.

### TECHNICAL FIELD

The present invention relates to a massage apparatus, and more particularly, to a sofa-type massage apparatus.

### BACKGROUND

Recently, massage apparatuses have been widely used not only for patients but also for the general public for the purpose of treatment and prevention. Such massage apparatuses include not only massage functions but also various functions such as treatment using heat, and their functions are expanding day by day.

And in general, massage apparatuses are formed so that the user can lie down, and various devices are provided inside to massage the user's body.

In other words, various devices are provided inside the massage apparatus, so when the user's body comes into contact, it feels foreign body sensation, so if the massage apparatus is not used, people will take a rest using furniture such as a sofa.

A bed equipped with a vibration member capable of performing a massage function is disclosed in Korean Registered Utility Model No. 20-0212407. In other words, an auxiliary bed that can be moved is installed under the bed where the user rests, and a vibration member is provided in this auxiliary bed, so that it is configured to perform massage by moving the auxiliary bed to the outside only when the vibration member is used.

However, as these vibration members were installed slightly protruding along the height direction to the upper surface of the mattress of the auxiliary bed, there was a limit to placing the frame of the bed high to prevent interference between the vibration members and the bed frame when moving the auxiliary bed.

Of course, in the case of furniture where users lie down and rest, such as beds, even if the frame is placed high, there is no big problem in using it, but in the case of furniture that sits and uses such as a sofa, when the frame rises, the leg falls from the ground while the user sits, which may cause discomfort.

In addition, if a large number of separation spaces are formed along the height direction between the lower surface of the bed frame and the upper surface of the auxiliary bed, there may be a problem that the durability of the vibration member is easily deteriorated as foreign substances enter easily.

Furthermore, there may be hygiene problems in the auxiliary bed due to foreign substances, and safety accidents such as hand jamming by users may occur due to this separated space.

Therefore, there is a need for improvement in this area.

### DISCLOSURE

### Technical Tasks

The present invention is to solve the above problems, and the present invention is directed to providing a sofa-type massage apparatus on which a user may sit down and rest, such as a sofa, but that can be withdrawn to the outside to perform a massage only when a massage is required.

The present invention is also directed to providing a sofa-type massage apparatus in which interference does not occur between a massage module and a support part in the process of withdrawing or inserting a withdrawal/insertion part.

The present invention is also directed to providing a sofa-type massage apparatus capable of minimizing the formation of a separation space along the height direction between the support part and the withdrawal/insertion part.

The problems of the present invention are not limited to those mentioned above, and other problems not mentioned will be clearly understood by those of ordinary skill in the art from the following description.

### Technical Solution

According to an aspect of the present invention, provided is a sofa-type massage apparatus, including a support part having a first support surface configured to support a body of a user; a withdrawal/insertion part which has a second support surface configured to support the body of the user, and has a massage module configured to move along the longitudinal direction so as to massage the body of the user who is lying down on the second support surface; and a controller configured to control the operation of the massage module, wherein the withdrawal/insertion part is disposed inside an accommodation space formed in the support part and is able to be withdrawable or insertable along the width direction so as to enable the second support surface to be selectively exposed to the outside.

In this case, the massage module may include a transfer part configured to move along the longitudinal direction; a pedestal part wherein an acupressure member for pressing the body of the user is disposed on one side of the pedestal part and the other side of the pedestal part is hinge-fixed to the transfer part; and a lifting/lowering part configured to raise or lower one side of the pedestal part, and when the withdrawal/insertion part is withdrawn so that the second support surface is exposed to the outside while the second support surface is placed to overlap the first support surface in the height direction, or when the withdrawal/insertion part is inserted so that the second support surface is placed to overlap the first support surface while the second support surface is exposed to the outside, the controller may control the operation of the massage module so that the acupressure member is placed at a lower position than the second support surface or at the same position as the second support surface along the height direction.

In this case, the controller may control the operation of the massage module so that the acupressure member presses the user's body while moving to a higher position than the second support surface along the height direction only when the second support surface is exposed to the outside so that the second support surface does not overlap the first support surface along the height direction.

In this case, the sofa-type massage apparatus may further include a first driving part configured to withdraw or insert the withdrawal/insertion part, and the controller may control the operation of the first driving part.

In this case, the first driving part may include a first guide member disposed along the width direction, and a first driving member configured to provide driving force so that the withdrawal/insertion part moves along the first guide member.

In this case, the sofa-type massage apparatus may further include a second driving part configured to adjust the height of the second support surface while the second support surface is exposed to the outside, and the controller may control the operation of the second driving part.

In this case, the second driving part may include a second guide member configured to raise or lower the second support surface along the height direction, and a second driving member configured to provide driving force for the second support surface to rise or descend.

In this case, the first driving part may further include a first detection member configured to detect whether the withdrawal/insertion part is withdrawn or inserted.

In this case, when a complete withdrawal signal of the withdrawal/insertion part is transmitted from the first detection member, the controller may convert the massage module into an operable state after a first waiting time has elapsed.

In this case, when an insertion signal of the withdrawal/insertion part is transmitted, the controller may control the operation of the first driving part to initiate an insertion operation of the withdrawal/insertion part after confirming that the acupressure member is placed at a lower position than the second support surface or the same position as the second support surface along the height direction.

In this case, the second driving part may further include a second detection member configured to detect a height of the second support surface.

In this case, the controller may control the operation of the second driving part so that the second support surface rises after the first waiting time has elapsed when a complete withdrawal signal of the withdrawal/insertion part is transmitted from the first detection member, and switch the massage module to an operable state after a second waiting time has elapsed when a complete raising signal of the second support surface is transmitted from the second detection member.

In addition, when an insertion signal of the withdrawal/insertion part is transmitted, the controller may control the operation of the first driving part to initiate an insertion operation of the withdrawal/insertion part after confirming that the acupressure member is placed at a lower position than the second support surface or the same position as the second support surface along the height direction and at the same time confirming that a complete lowering signal of the second support surface is transmitted from the second detection member.

In this case, the controller may control the operation of the massage module so that the acupressure member presses the user's body while moving to a higher position than the second support surface along the height direction only when the second support surface is exposed to the outside so that the second support surface does not overlap the first support surface along the height direction, and the height of the second support surface is raised.

### Advantageous Effect

According to the above configuration, in the sofa-type massage apparatus according to an exemplary embodiment of the present invention, as the withdrawal/insertion part placed inside the accommodation space formed in the support part is withdrawn or inserted along the width direction, the second support surface is selectively exposed to the outside, whereby the user may sit down and rest thereon and the withdrawal/insertion part may be withdrawn to the outside to perform a massage only when the massage is necessary, thereby improving user convenience and space efficiency.

In addition, in the sofa-type massage apparatus according to an exemplary embodiment of the present invention, when the withdrawal/insertion part is withdrawn or inserted, the controller controls the operation of the massage module so that the acupressure member is placed at a lower position than the second support surface or at the same position as the second support surface along the height direction, so that there is no interference between the massage module and the support part during the withdrawal or insertion process, thereby securing the stability of the withdrawal or insertion operation of the withdrawal part.

Furthermore, in the sofa-type massage apparatus according to an exemplary embodiment of the present invention, only when the second support surface is exposed to the outside, the controller controls the operation of the massage module so that the acupressure member presses the user's body while moving to a higher position than the second support surface along the height direction, whereby the formation of a separation space between the support part and the withdrawal/insertion part is minimized along the height direction, thereby increasing durability by preventing the inflow of foreign substances and preventing safety accidents caused by the user's hands getting caught.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view of a sofa-type massage apparatus according to an exemplary embodiment of the present invention, showing a state in which a withdrawal/insertion part is inserted into a support part.

FIG. 2 is a perspective view of a sofa-type massage apparatus according to an exemplary embodiment of the present invention, showing a state in which a withdrawal/insertion part is withdrawn from a support part.

FIG. 3 is a perspective view of a sofa-type massage apparatus according to an exemplary embodiment of the present invention, showing the arrangement of a massage module in a state in which a withdrawal/insertion part is inserted into a support part.

FIG. 4 is an enlarged perspective view showing the massage module of FIG. 3.

FIG. 5 is a cross-sectional view of part I-I in FIG. 1.

FIG. 6 is a cross-sectional view of part II-II in FIG. 2, showing a state in which one side of a pedestal part of a massage module is raised.

FIG. 7 is a cross-sectional view of part III-III in FIG. 1.

FIG. 8 is a perspective view of a sofa-type massage apparatus according to an exemplary embodiment of the present invention, showing a state in which the height of a second support surface of a withdrawal/insertion part is increased.

FIG. 9 is a cross-sectional view of part VI-VI in FIG. 8.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

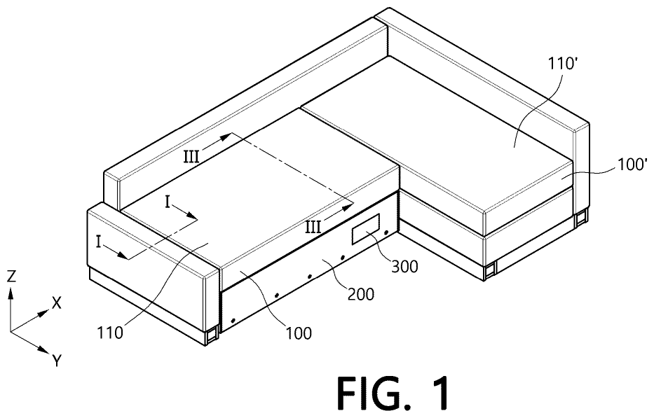

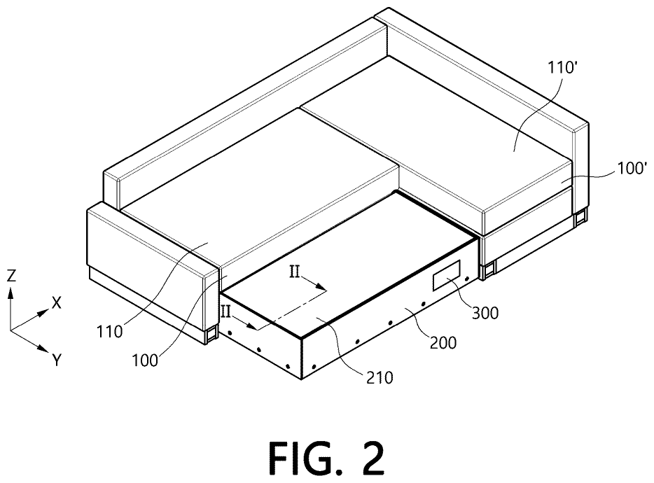

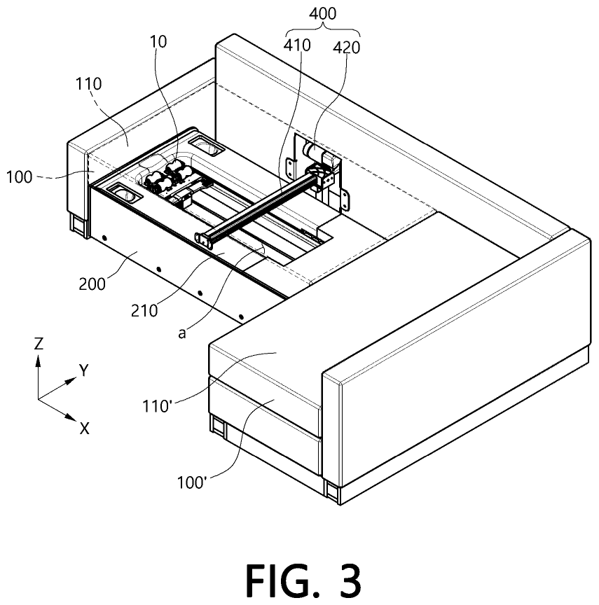

FIG. 1 is a perspective view of a sofa-type massage apparatus according to an exemplary embodiment of the present invention, showing a state in which a withdrawal/insertion part is inserted into a support part, FIG. 2 is a perspective view of a sofa-type massage apparatus according to an exemplary embodiment of the present invention, showing a state in which a withdrawal/insertion part is withdrawn from a support part, and FIG. 3 is a perspective view of a sofa-type massage apparatus according to an exemplary embodiment of the present invention, showing the arrangement of a massage module in a state in which a withdrawal/insertion part is inserted into a support part. Here, the X direction means the longitudinal direction, the Y direction means the width direction, and the Z direction means the height direction. For clarity of description of the present invention, parts not related to the description are omitted in the drawings.

As shown in FIG. 1, the sofa-type massage apparatus according to an exemplary embodiment of the present invention includes a support part 100 which has a first support surface 110 for supporting the body of a user.

The first support surface 110 provided in the support part 100 may be configured to have a height in which a user may sit and rest along the height direction Z, and a separate auxiliary support part 100′ may be connected to the support part 100. For example, when the support part 100 is disposed to extend along the longitudinal direction X, the auxiliary support part 100′ may be configured to be disposed to extend along the width direction Y.

The auxiliary support part 100′ may also be provided with an auxiliary support surface 110′ supporting the user's body, and when the auxiliary support part 100′ is connected in this way, the user can not only sit down and rest, but also lie down and rest.

In addition, it is also possible to configure the auxiliary support surface 110′ to be open and to use to store items inside the auxiliary support part 100′.

In addition, as shown in FIG. 2, a withdrawal/insertion part 200 having a massage module 10 is included so that the user can receive a massage while lying down thereon. The withdrawal/insertion part 200 is provided with a second support surface 210 for supporting the user's body so that the user may lie down thereon. The second support surface 210 may be a pad supporting the user's body.

In other words, it is configured such that the user sits on the first support surface 110 of the support part 100 and takes a rest, and then lies down on the second support surface 210 of the withdrawal/insertion part 200 and receives a massage if a massage is needed. When the user lies on the second support surface 210, the massage module 10 moves along the longitudinal direction X to perform a massage.

A controller 300 for controlling the operation of the massage module 10 is provided.

In this case, as shown in FIG. 3, the withdrawal/insertion part 200 is placed inside the accommodation space (a) formed in the support part 100, and is configured to be withdrawn or inserted along the width direction Y so that the second support surface 210 is selectively exposed to the outside.

In other words, as the withdrawal/insertion part 200 placed inside the accommodation space (a) formed in the support part 100 is withdrawn or inserted along the width direction Y, the second support surface 210 is selectively exposed to the outside, whereby the user may sit down and rest thereon and the withdrawal/insertion part 200 may be withdrawn to the outside to perform a massage only when the massage is necessary, thereby improving user convenience and space efficiency.

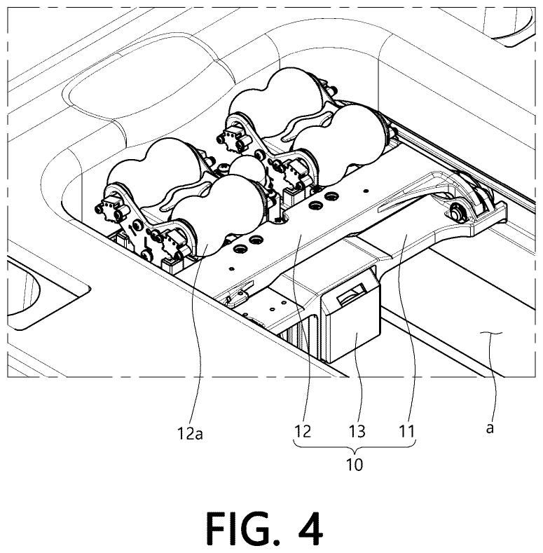

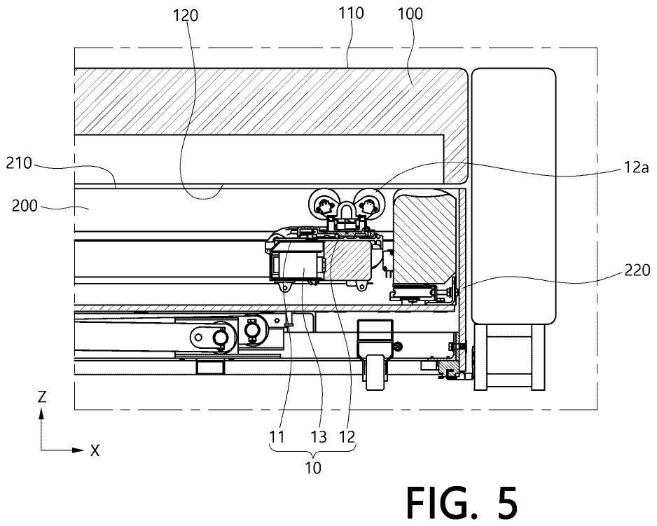

FIG. 4 is an enlarged perspective view showing the massage module of FIG. 3, and FIG. 5 is a cross-sectional view of part I-I in FIG. 1.

As shown in FIG. 4, the massage module 10 includes a transfer part 11 that moves along the longitudinal direction X; a pedestal part 12 wherein an acupressure member 12a for pressing the body of a user is disposed on one side of the pedestal part and the other side of the pedestal part is hinge-fixed to the transfer part 11; and a lifting/lowering part 13 that raises or lowers one side of the pedestal part 12.

The transfer part 11 may include a plate-shaped base plate and base ribs provided at both ends of the base plate in the width direction Y. A support roller may be provided on the base rib, and the support roller may be movably disposed along a guide rail disposed along the longitudinal direction X. A transfer motor providing a driving force so that the support roller moves along the guide rail may be provided in the transfer part 11.

In addition, an acupressure member 12a may be disposed on the upper surface of one side of the pedestal part 12, and the other side of the pedestal part 12 may be hinge-fixed to the transfer part 11. In other words, when one side of the pedestal part 12 rises through the operation of the lifting/lowering part 13, the acupressure member 12a rises together, and since the other side of the pedestal part 12 is hinge-fixed, as one side of the pedestal part 12 rises while drawing a circular arc, the effect of pressing in the height direction Z and the effect of pushing in the longitudinal direction X can be provided in combination, thereby improving the massage effect. The acupressure members 12a may be disposed on both sides of the pedestal part 12 in the width direction Y, respectively.

In this case, as shown in FIG. 5, when the withdrawal/insertion part 200 is withdrawn or inserted, the controller 300 may control the operation of the massage module 10 so that the acupressure member 12a is placed at a lower position than the second support surface 210 or the same position as the second support surface 210 along the height direction Z.

In general, the shape of the user's spine is different for each user, and a massage is performed such that in order to perform the massage according to the different spine shapes, the controller 300 controls the massage module 10 to move along the longitudinal direction X through the movement of the transfer part 11 and at the same time controls one side of the pedestal part 12 to rise through the movement of the lifting/lowering part 13 so that the acupressure member 12a moves to a higher position than the second support surface 210 and presses the user's body.

However, since the user's body is massaged in this way, it is important to configure the massage module 10 and the support part 100 not to interfere with each other when the withdrawal/insertion part 200 is withdrawn or inserted, and to this end, when the withdrawal/insertion part 200 is withdrawn or inserted, the controller 300 is configured to control the operation of the massage module 10 so that the acupressure member 12a is placed at a lower position than the second support surface 210 or at the same position as the second support surface 210 along the height direction Z.

In this case, the withdrawal or insertion of the withdrawal/insertion part 200 means that the withdrawal/insertion part 200 is withdrawn so that the second support surface 210 is completely exposed (completely withdrawn) to the outside from a state in which the second support surface 210 is overlapped with the first support surface 110 along the height direction Z or that the withdrawal/insertion part 200 is inserted so that the second support surface 210 is overlapped with the first support surface 110 from a state in which the second support surface 210 is completely exposed (completely withdrawn) to the outside.

With this configuration, even when the height of the support part 100 is lowered, the massage module 10 does not interfere with the support part 100, allowing the user to sit comfortably on the support part 100 and rest, and securing the stability of the withdrawal or insertion operation of the withdrawal/insertion part 200.

In addition, the controller 300 may control the massage module 10 to pause the operation if the user stands up while receiving a massage when the massage process does not end, and in this way, when the operation of the massage module 10 is temporarily stopped, the acupressure member 12a stops at an arbitrary height (a height just before the user gets up) along the height direction Z. This is to perform a continuous massage again from the paused part when the user lies down again to receive a massage.

However, if the acupressure member 12a is temporarily stopped while being placed higher than the second support surface 210, and the user controls the withdrawal/insertion part 200 to be inserted without checking the position of the acupressure member 12a in advance (including when the user directly applies an external force to insert the withdrawal/insertion part 200, as well as when the withdrawal/insertion part 200 is inserted using a separate button), the controller 300 is configured to control the operation of the massage module 10 so that the acupressure member 12a is placed at a lower position than the second support surface 210 or at the same position as the second support surface 210 along the height direction Z, thereby preventing damage to the massage module 10 and enabling a smooth insertion operation of the withdrawal/insertion part 200.

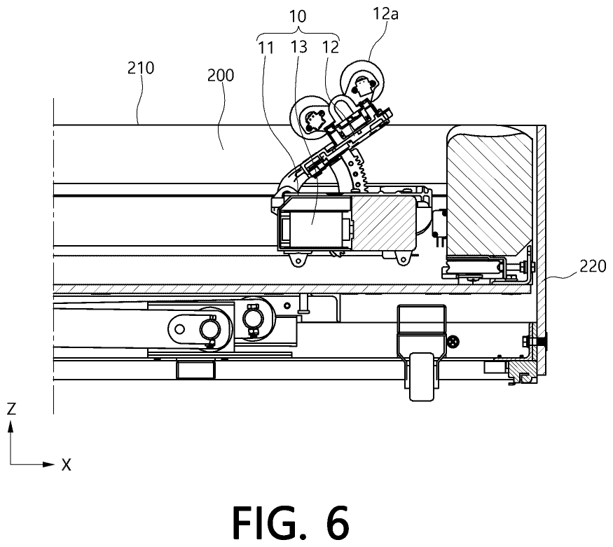

FIG. 6 is a cross-sectional view of part II-II in FIG. 2, showing a state in which one side of a pedestal part of a massage module is raised.

As shown in FIG. 6, the controller 300 may control the operation of the massage module 10 so that the acupressure member 12a presses the user's body while moving to a higher position than the second support surface 210 along the height direction Z only when the second support surface 210 is exposed to the outside. In this case, when the withdrawal/insertion part 200 is exposed to the outside, it means that the withdrawal/insertion part 200 is completely withdrawn, which means that the second support surface 210 does not overlap the first support surface 110 along the height direction Z. In addition, this may mean that the pad on which the second support surface 210 is formed is completely withdrawn so as not to overlap with the support part 100 along the height direction Z.

As described above, a massage is performed such that the controller 300 controls one side of the pedestal part 12 to rise through the operation of the lifting/lowering part 13 only when the second support surface 210 is exposed to the outside, so that the acupressure member 12a moves to a higher position than the second support surface 210 along the height direction Z and presses the user's body.

In other words, as it is configured so that the acupressure member 12a moves to a higher position than the second support surface 210 along the height direction Z only during the massage is performed, even when the lower surface 120 of the support part 100 and the first support surface 110 of the withdrawal/insertion part 200 are disposed adjacent to each other, interference does not occur between them during the withdrawal or insertion process of the withdrawal/insertion part 200, and it is possible to minimize the formation of separation space between them. This configuration prevents the inflow of foreign substances and thus increases durability, and it is possible to prevent safety accidents from occurring as the user's hand is caught in such separation space.

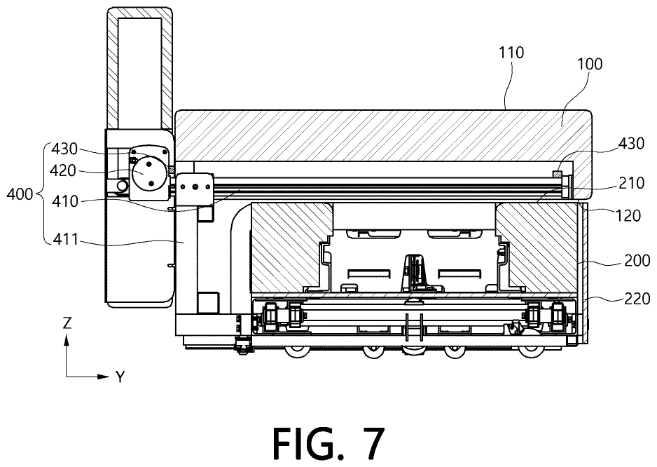

FIG. 7 is a cross-sectional view of part III-III in FIG. 1.

As shown in FIG. 7, a first driving part 400 for withdrawing or inserting the withdrawal/insertion part 200 is further included, and the controller 300 may control the operation of the first driving part 400.

That is, the first driving part 400 is provided, and the controller 300 is configured to control the operation of the first driving part 400, so that the withdrawal/insertion part 200 may be withdrawn or inserted in a simple manner in which the user presses a separate button.

In this case, the first driving part 400 may include a first guide member 410 disposed along the width direction Y and a first driving member 420 that provides driving force for the withdrawal/insertion part 200 to move along the first guide member 410.

The first guide member 410 may be attached to the lower surface 120 of the support part 100, and a separate connection frame 411 connecting the first guide member 410 and the withdrawal/insertion part 200 may be provided in the first driving part 400.

That is, the first driving member 420 provides driving force so that the connection frame 411 moves in the width direction Y along the first guide member 410. The first driving member 420 may be a linear actuator that provides driving force for the connection frame 411 to move along the first guide member 410.

A separate withdrawal/insertion frame 220 may be provided to surround the circumference of the pad to prevent the pad having the second support surface 210 from being damaged during the withdrawal or insertion process of the withdrawal/insertion part 200.

However, the first driving member 420 is not limited to the linear actuator, and any configuration can be used as long as it can provide driving force so that the withdrawal/insertion part 200 moves along the width direction Y.

As an example, the first guide member 410 may be replaced with a link structure such as a scissor link, and the first driving member 420 may be replaced with an actuator capable of operating the scissor link.

As another example, the first guide member 410 may be replaced with a rack gear, and the first driving member 420 may be replaced with a driving motor having a pinion gear to move along such a rack gear. In this case, the rack gear may be configured to be fixed to the support part 100, and the driving motor may be configured to be fixed to the withdrawal/insertion part 200.

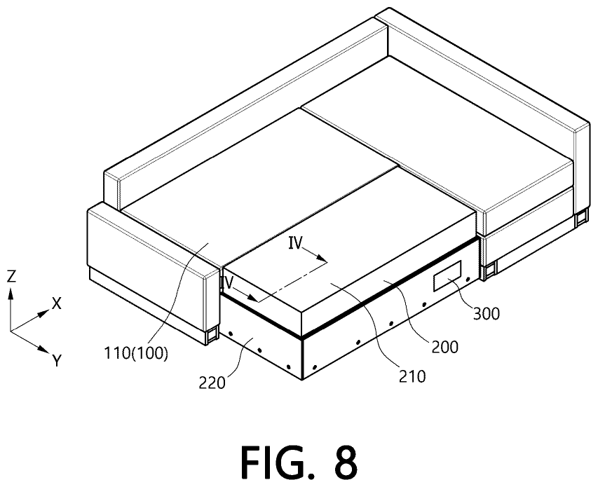

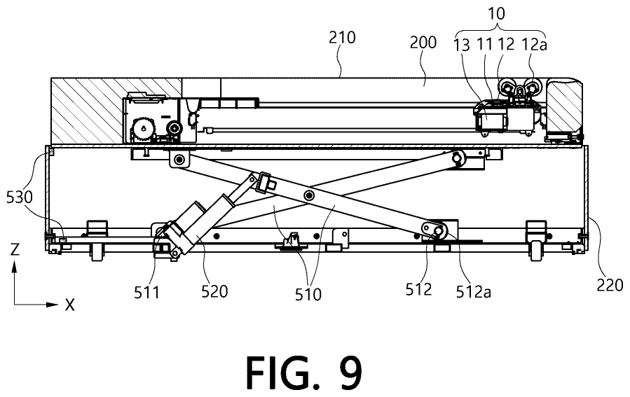

FIG. 8 is a perspective view of a sofa-type massage apparatus according to an exemplary embodiment of the present invention, showing a state in which the height of a second support surface of a withdrawal/insertion part is increased, and FIG. 9 is a cross-sectional view of part VI-VI in FIG. 8.

As shown in FIG. 8, the second support surface 210 may be configured to be lifted so that the height of the second support surface 210 corresponds to the height of the first support surface 110 while the withdrawal/insertion part 200 is withdrawn from the support part 100.

To this end, as shown in FIG. 9, a second driving part 500 for adjusting the height of the second support surface 210 while the second support surface 210 is exposed to the outside is further included, and the controller 300 may control the operation of the second driving part 500.

That is, the second driving part 500 is provided, and the controller 300 is configured to control the operation of the second driving part 500, so that the height of the second support surface 210 may be simply increased.

It is also possible to configure the controller 300 to control the operation of the first driving part 400 and the second driving part 500 so that the height of the second support part 100 can be increased after withdrawing the withdrawal/insertion part 200 in a simple way that the user presses a separate button.

Conversely, it is also possible to configure the controller 300 to control the operation of the first driving part 400 and the second driving part 500 so that the withdrawal/insertion part 200 can be inserted after decreasing the height of the second support part 100 in a simple way that the user presses a separate button.

In this case, the second driving part 500 may include a second guide member 510 that raises or lowers the second support surface 210 along the height direction Z, and a second driving member 520 that provides driving force for the second support surface 210 to rise or descend.

To this end, the second driving part 500 increases the height of the pad, and at this time, the height of the withdrawal/insertion frame 220 described above is fixed, and only the height of the pad is increased. The second guide member 510 may be a scissor link having one end attached to the lower surface 120 of the withdrawal/insertion frame 220 and the other end attached to the lower surface of the pad. The second driving member 520 may be an actuator that increases the height of the other end of the second guide member 510.

As an example, one end of the second guide member 510 may be a fixed end 511 fixed to the lower surface of the withdrawal/insertion frame 220, and the other end of the second guide member 510 may be a movable end 512 that can slide along the lower surface of the pad. A movable roller 512a may be provided for the smooth sliding movement of the movable end 512.

As another example, one end of the second guide member 510 may be also a fixed end 511 fixed to the lower surface of the pad, and the other end of the second guide member 510 may be also a movable end 512 that can slide along the lower surface of the withdrawal/insertion frame 220.

The second driving part 500 is not limited to the above configuration, and any configuration may be used as long as the height of the second support surface 210 may be adjusted. As another example, the second driving part 500 may be a linear actuator capable of adjusting the height of the pad.

As shown in FIG. 7, the first driving part 400 may further include a first detection member 430 for detecting whether the withdrawal/insertion part 200 is withdrawn or inserted.

The first detection member 430 may simply be a switch that may be pressed when the withdrawal/insertion part 200 is completely withdrawn or inserted, or may be a sensor capable of detecting the position of the withdrawal/insertion part 200.

In other words, through the first detection member 430, the controller 300 may check whether the withdrawal/insertion part 200 is fully withdrawn or inserted, and by reflecting this and configuring the operation of the massage module 10 to be controlled, it is possible to prevent the massage module 10 from being damaged during the withdrawal or insertion process of the withdrawal/insertion part 200.

In this case, when a complete withdrawal signal of the withdrawal/insertion part 200 is transmitted from the first detection member 430, the controller 300 may convert the massage module 10 into an operable state after the first waiting time has elapsed.

In other words, the massage module 10 is controlled to be operable when the withdrawal/insertion part 200 is fully withdrawn and the first waiting time has elapsed, thereby preventing the massage module 10 from being damaged during the withdrawal process of the withdrawal/insertion part 200.

For example, the controller 300 starts the operation of the massage module 10 according to the mode selected by the user when a predetermined preparation time elapses without additional movement after the user lies down on the second support surface 210. This is to ensure that the user is ready to receive a massage. Whether there is a user's movement may be detected through a separate detection member such as a load cell provided in the massage module 10.

In this case, the above-described preparation time may be configured to be calculated after the massage module 10 is switched to an operable state. In other words, even if the user lies down without the withdrawal/insertion part 200 being fully withdrawn, the preparation time is not calculated, and if it is configured so that the preparation time is calculated after the withdrawal/insertion part 200 is fully withdrawn and the first waiting time has elapsed, damage to the massage module 10 is prevented during the withdrawal process, and stable operation of the massage module 10 is possible.

In this case, when an insertion signal of the withdrawal/insertion part 200 is transmitted, the controller 300 may control the operation of the first driving part 400 to initiate the insertion operation of the withdrawal/insertion part 200 after confirming that the acupressure member 12a is placed at a lower position than the second support surface 210 or the same position as the second support surface 210 along the height direction Z.

As described above, the controller 300 may control the massage module 10 to pause the operation if the user stands up while receiving a massage when the massage process does not end, and in this way, when the operation of the massage module 10 is temporarily stopped, the acupressure member 12a stops at an arbitrary height (a height just before the user gets up) along the height direction Z so that the user can lie down again and receive continuous massage.

However, if the acupressure member 12a is temporarily stopped while being placed higher than the second support surface 210, and the user enters an insertion signal using a separate button so that the withdrawal/insertion part 200 is inserted without checking the position of the acupressure member 12a in advance, the controller 300 controls the operation of the first driving part 400 to initiate the insertion operation of the withdrawal/insertion part 200 after confirming that the acupressure member 12a is placed at a lower position than the second support surface 210 or the same position as the second support surface 210 along the height direction Z.

That is, if the acupressure member 12a is placed at a position lower than the second support surface 210 or the same position as the second support surface 210 along the height direction Z, the controller 300 controls the operation of the first driving part 400 so that the withdrawal/insertion part 200 is immediately inserted, and it is also possible to move the massage module 10 together in the longitudinal direction X so that the massage module 10 is placed at the initial position in the process of inserting the withdrawal/insertion part 200. In this case, it is important to move the massage module 10 while the height of the acupressure member 12a is kept constant.

As shown in FIG. 9, the second driving part 500 may further include a second detection member 530 for detecting a height of the second support surface 210.

The second detection member 530 may simply be a switch that may be pressed when the second detection member 210 is completely raised or lowered, or may be a sensor capable of detecting the position of the second support surface 210. It is also possible to configure the second detection member 530 to detect the height of the pad.

In other words, through the second detection member 530, the controller 300 may check whether the second support surface 210 is fully raised or lowered, and by reflecting this and configuring the operation of the massage module 10 to be controlled, it is possible to prevent the massage module 10 from being damaged during the withdrawal or insertion process of the withdrawal/insertion part 200.

In this case, the controller 300 may control the operation of the second driving part 500 so that the second support surface 210 rises after the first waiting time has elapsed when a complete withdrawal signal of the withdrawal/insertion part 200 is transmitted from the first detection member 430, and may switch the massage module 10 to an operable state after the second waiting time has elapsed when a complete raising signal of the second support surface (210) is transmitted from the second detection member 530.

In other words, by allowing the second support surface 210 to rise after the first waiting time has elapsed after the withdrawal/insertion part 200 is withdrawn, it is possible to prevent the massage module 10 or the second driving part 500 from being damaged due to the rise of the second support surface 210 while the withdrawal/insertion part 200 is not completely withdrawn.

For example, the controller 300 starts the operation of the massage module 10 according to the mode selected by the user when a predetermined preparation time elapses without additional movement after the user lies down on the second support surface 210. This is to ensure that the user is ready to receive a massage, and whether there is the user's movement may be detected through a separate detection member such as a load cell provided in the massage module 10.

In this case, the above-described preparation time may be configured to be calculated after the massage module 10 is switched to an operable state. That is, when it is configured so that the preparation time is not calculated even if the user lies down without the second support surface 210 completely rising, and the preparation time is calculated after the second support surface 210 is completely raised, and the second waiting time has elapsed, a stable operation of the massage module 10 is possible.

The first waiting time and the second waiting time may be set to be the same, but it is also possible to set the first waiting time relatively shorter than the second waiting time so that the second support surface 210 rises almost continuously after withdrawal of the withdrawal/insertion part 200.

In this case, when an insertion signal of the withdrawal/insertion part 200 is transmitted, the controller 300 may control the operation of the first driving part 400 to initiate the insertion operation of the withdrawal/insertion part 200 after confirming that the acupressure member 12a is placed at a lower position than the second support surface 210 or the same position as the second support surface 210 along the height direction Z and at the same time confirming that a complete lowering signal of the second support surface 210 is transmitted from the second detection member 530.

As described above, the controller 300 may control the massage module 10 to pause the operation if the user stands up while receiving a massage when the massage process does not end, and in this way, when the operation of the massage module 10 is temporarily stopped, the acupressure member 12a stops at an arbitrary height (a height just before the user gets up) along the height direction Z so that the user can lie down again and receive continuous massage.

However, if the acupressure member 12a is temporarily stopped while being placed higher than the second support surface 210, and the user enters an insertion signal using a separate button so that the withdrawal/insertion part 200 is inserted without checking the position of the acupressure member 12a in advance, the controller 300 controls the operation of the first driving part 400 to initiate the insertion operation of the withdrawal/insertion part 200 after not only confirming that the acupressure member 12a is placed at a lower position than the second support surface 210 or the same position as the second support surface 210 along the height direction Z, but also confirming whether the second support surface 210 is completely lowered.

In other words, when the acupressure member 12a is placed at a lower position than the second support surface 210 or the same position as the second support surface 210 along the height direction Z, the controller 300 controls only the operation of the second driving part 500 so that the second support surface 210 descends, but when the acupressure member 12a is placed at a higher position than the second support surface 210, the controller 300 controls the operation of the second driving part 500 so that the second support surface 210 descends, and at the same time controls the massage module 10 so that the acupressure member 12a descends to a lower position than or the same position as the second support surface 210. In this case, the controller 300 may also move the massage module 10 together in the longitudinal direction X so that the massage module 10 is placed in the initial position while the acupressure member 12a descends to a lower position than or the same position as the second support surface 210.

Meanwhile, only when the second support surface 210 is exposed to the outside so that the second support surface does not overlap with the first support surface 110 along the height direction Z, and the height of the second support surface 210 is raised, the controller 300 may control the operation of the massage module 10 so that the acupressure member 12a presses the user's body while moving to a higher position than the first support surface 110 along the height direction Z.

That is, it may be configured so that the massage is performed while the height of the second support surface 210 is raised after the second support surface 210 is withdrawn, but the height of the second support surface 210 rises to the same height as the first support surface 110 or only to a lower position than the first support surface 110. When configured in this way, it is possible to secure the view of not only the user who lies on the second support surface 210 and receives a massage, but also other users who lie on the first support surface 110 and rest.

As described above, it may be configured so that when the second support surface 210 is withdrawn and the height of the second support surface 210 is increased, the massage module 10 operates to perform a massage, but the height of the acupressure member 12a presses the user's body while moving to a higher position than the first support surface 110. For example, there is a case in which the user lies on the first support surface 110 and takes a rest and wants to receive a massage only for a part of the user's body, such as an arm or a leg. In this case, since the user lies on the first support surface 110 and places only a part of the body that wants to be massaged on the second support surface 210, a more effective massage is possible by setting the reference position of the height at which the acupressure member 12a moves as the first support surface 110.

As previously discussed, in the sofa-type massage apparatus according to an exemplary embodiment of the present invention, since the withdrawal/insertion part 200 is configured to be placed inside the accommodation space (a) formed in the support part 100, and to be withdrawable or insertable along the width direction Y so that the second support surface 210 is selectively exposed to the outside, the second support surface 210 is selectively exposed to the outside, whereby the user may sit down and rest thereon and the withdrawal/insertion part 200 may be withdrawn to the outside to perform a massage only when the massage is necessary, thereby improving user convenience and space efficiency.

In addition, since when the withdrawal/insertion part 200 is withdrawn or inserted, the controller 300 is configured to control the operation of the massage module 10 so that the acupressure member 12a is placed at a lower position than the second support surface 210 or at the same position as the second support surface 210 along the height direction Z, even when the height of the support part 100 is lowered, the massage module 10 does not interfere with the support part 100, allowing the user to sit comfortably on the support part 100 and rest, and securing the stability of the withdrawal or insertion operation of the withdrawal/insertion part 200.

Furthermore, as it is configured so that the acupressure member 12a moves to a higher position than the second support surface 210 along the height direction Z only during the massage is performed, even when the lower surface 120 of the support part 100 and the first support surface 110 of the withdrawal/insertion part 200 are disposed adjacent to each other, interference does not occur between them during the withdrawal or insertion process of the withdrawal/insertion part 200, and it is possible to minimize the formation of separation space between them. This configuration prevents the inflow of foreign substances and thus increases durability, and it is possible to prevent safety accidents from occurring as the user's hand is caught in such separation space.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.

1. A sofa-type massage apparatus, comprising:
a support part having a first support surface configured to support a body of a user;
a withdrawal/insertion part which has a second support surface configured to support the body of the user, and has a massage module configured to move along the longitudinal direction so as to massage the body of the user who is lying down on the second support surface; and
a controller configured to control the operation of the massage module,
wherein the withdrawal/insertion part is disposed inside an accommodation space formed in the support part and is able to be withdrawable or insertable along the width direction so as to enable the second support surface to be selectively exposed to the outside.

2. The sofa-type massage apparatus of claim 1,
wherein the massage module comprises a transfer part configured to move along the longitudinal direction; a pedestal part wherein an acupressure member for pressing the body of the user is disposed on one side of the pedestal part and the other side of the pedestal part is hinge-fixed to the transfer part; and a lifting/lowering part configured to raise or lower one side of the pedestal part, and
wherein when the withdrawal/insertion part is withdrawn so that the second support surface is exposed to the outside while the second support surface is placed to overlap the first support surface in the height direction, or when the withdrawal/insertion part is inserted so that the second support surface is placed to overlap the first support surface while the second support surface is exposed to the outside, the controller is configured to control the operation of the massage module so that the acupressure member is placed at a lower position than the second support surface or at the same position as the second support surface along the height direction.

3. The sofa-type massage apparatus of claim 2,
wherein the controller is configured to control the operation of the massage module so that the acupressure member presses the user's body while moving to a higher position than the second support surface along the height direction only when the second support surface is exposed to the outside so that the second support surface does not overlap the first support surface along the height direction.

4. The sofa-type massage apparatus of claim 1,
further comprising a first driving part configured to withdraw or insert the withdrawal/insertion part,
wherein the controller is configured to control the operation of the first driving part.

5. The sofa-type massage apparatus of claim 4,
wherein the first driving part comprises a first guide member disposed along the width direction, and a first driving member configured to provide driving force so that the withdrawal/insertion part moves along the first guide member.

6. The sofa-type massage apparatus of claim 5,
further comprising a second driving part configured to adjust the height of the second support surface while the second support surface is exposed to the outside,
wherein the controller is configured to control the operation of the second driving part.

7. The sofa-type massage apparatus of claim 6,
wherein the second driving part comprises a second guide member configured to raise or lower the second support surface along the height direction, and a second driving member configured to provide driving force for the second support surface to rise or descend.

8. The sofa-type massage apparatus of claim 7,
wherein the first driving part further comprises a first detection member configured to detect whether the withdrawal/insertion part is withdrawn or inserted.

9. The sofa-type massage apparatus of claim 8,
wherein when a complete withdrawal signal of the withdrawal/insertion part is transmitted from the first detection member, the controller is configured to convert the massage module into an operable state after a first waiting time has elapsed.

10. The sofa-type massage apparatus of claim 9,
wherein when an insertion signal of the withdrawal/insertion part is transmitted, the controller is configured to control the operation of the first driving part to initiate an insertion operation of the withdrawal/insertion part after confirming that the acupressure member is placed at a lower position than the second support surface or the same position as the second support surface along the height direction.

11. The sofa-type massage apparatus of claim 8,
wherein the second driving part further comprises a second detection member configured to detect a height of the second support surface.

12. The sofa-type massage apparatus of claim 11,
wherein the controller is configured to:
control the operation of the second driving part so that the second support surface rises after the first waiting time has elapsed when a complete withdrawal signal of the withdrawal/insertion part is transmitted from the first detection member, and
switch the massage module to an operable state after a second waiting time has elapsed when a complete raising signal of the second support surface is transmitted from the second detection member.

13. The sofa-type massage apparatus of claim 12,
wherein when an insertion signal of the withdrawal/insertion part is transmitted, the controller is configured to control the operation of the first driving part to initiate an insertion operation of the withdrawal/insertion part after confirming that the acupressure member is placed at a lower position than the second support surface or the same position as the second support surface along the height direction and at the same time confirming that a complete lowering signal of the second support surface is transmitted from the second detection member.

14. The sofa-type massage apparatus of claim 6,
wherein the controller is configured to control the operation of the massage module so that the acupressure member presses the user's body while moving to a higher position than the second support surface along the height direction only when the second support surface is exposed to the outside so that the second support surface does not overlap the first support surface along the height direction, and the height of the second support surface is raised.
